(19) United States
(12) Patent Application Publication
(10) Pub. No.: US 2004/0266518 A1
(43) Pub. Date: Dec. 30, 2004

(54) Gaming machine having a touch screen display

(76) Inventor: Michael Gauselmann, Espelkamp (DE)

Correspondence Address: PATENT LAW GROUP LLP, 2635 NORTH FIRST STREET, SUITE 223, SAN JOSE, CA, 95134, US

(21) Appl. No.: 10/752,139

(22) Filed: Jan. 5, 2004

Related U.S. Application Data
(63) Continuation-in-part of application No. 10/603,455, filed on Jun. 24, 2003.

(51) Int. Cl. A63F 13/00

(52) U.S. Cl. 463/20

(57) ABSTRACT

An OLED display or a 3-dimensional display is used in a gaming machine to create an image of a control device (e.g., a button, steering wheel, etc.). A touch screen lamination is provided so that the player touching the perceived control device generates control signals for controlling the game. Other types of devices are also disclosed.

### CROSS-REFERENCE TO RELATED APPLICATIONS

This application is a continuation-in-part of U.S. application Ser. No. 10/603,455, filed on Jun. 24, 2003, incorporated herein by reference.

### FIELD OF THE INVENTION

This invention relates to gaming machines, sometimes referred to as slot machines, and, in particular, to a light emitting diode display in a reel-type gaming machine.

### BACKGROUND

Gaming machines, also referred to as slot machines, in a casino are generally very similar. Such machines use motor-driven reels or video representations of reels, and the combinations of symbols across one or more pay lines determine the award granted to a player. Typically, mechanical push button switches are used to control the game. In some video gaming machines, a touch screen layer is laminated over the video display screen for the game, and the player touches images of virtual push button switches to perform the control function.

What is needed is a gaming machine that has characteristics that make the machine stand out so that it is more attractive to a player. What is also needed is a gaming machine that can be quickly reconfigured to play a different game.

### SUMMARY

Various embodiments of gaming machines are described that use attention-getting display techniques. The displays also provide flexibility.

In one embodiment, an OLED display is used in a reel-type gaming machine. In one embodiment, only a section of a reel strip is replaced by an OLED display. The section may only display one symbol. The OLED symbol may be a special symbol used in a high value symbol combination. The symbol may dynamically change to any other image during the game itself or may provide, for example, a celebration display or a highlighted image if the symbol is used in a winning combination. Accordingly, the OLED display adds uniqueness and excitement to the gaming machine with little additional complexity and cost.

In another embodiment, at least a visible portion of a reel's circumference is provided with an OLED display, and the reels do not move. The LEDs on the OLED display are energized in such a way (scrolled) as to simulate the movement of symbols on a reel rotated by a motor. Such a gaming machine is a hybrid between a pure video gaming machine and a motor-driven reel-type machine. The reels appear to a player to be actual motor-driven reels, and the electronic control of the LEDs to simulate the rotation may be indistinguishable from actual reel rotation. The gaming machine may be manufactured inexpensively since there is no requirement for stepper motors and the controls for operating the stepper motors. Simulated sounds may be generated to simulate the sounds of reels starting and stopping.

In one embodiment, conventional rotating reels, or any reel incorporating an OLED, are viewable behind a transparent display window. The display window is a transparent electronic display that can be controlled to display any opaque or translucent image. In one embodiment, the display window is a liquid crystal display (LCD). The LCD may also be a touch screen, and icons may be displayed superimposed in front of the reel symbols so that players can effectively touch the symbols on the reels to perform certain functions. Such functions may be to hold a reel (or an OLED symbol) during the next game. The display window may be used to highlight any winning combinations of symbols on the reels or convey any other information. The LCD may provide a celebration type of screen, and may even provide the controls for the player to operate a game, such as spin the reels, bet max, etc.

In another embodiment, the display window is a transparent touch screen but cannot display images.

In another embodiment, the display glass in areas other than the transparent openings for viewing the reels (or any other game display) may be an OLED display, an LCD, a 3-D image display (including holographic displays) or other type of display to enable the display glass to display any programmed images. The display glass may be controlled to display any image, even an image that is used in playing a game.

In yet another embodiment, the programmable display glass surrounding the reels or video display has a touch screen lamination that allows the player to make selections by touching a particular area of the display glass.

In other embodiments, a touch screen lamination is used in combination with a holographic image to give the player the illusion that the player is touching a three dimensional control device.

Many other embodiments may be made using the above-identified inventions.

### BRIEF DESCRIPTION OF THE DRAWINGS

FIG. 1 is a front view of a reel-type gaming machine that may incorporate the present invention.

FIG. 2 is a perspective view of three motor-driven reels in the gaming machine of FIG. 1, wherein one or more symbols on a reel strip around each reel is created by an OLED display.

FIG. 3 is a side view of a reel frame, around which the reel strip is adhered, showing a control cable to the OLED display and to an electrical connector slip ring for maintaining electrical contact with a controller as the reel rotates about an axis.

FIG. 4 is a perspective view of three stationary reels, each including an OLED display that simulates the movement of symbols on a rotating reel.

FIGS. 5, 6, and 7 illustrate the physical reel symbols with superimposed images created by a transparent display screen in front of the reels.

FIG. 8 is a block diagram of certain functional blocks in a gaming machine incorporating the present invention.

### DETAILED DESCRIPTION

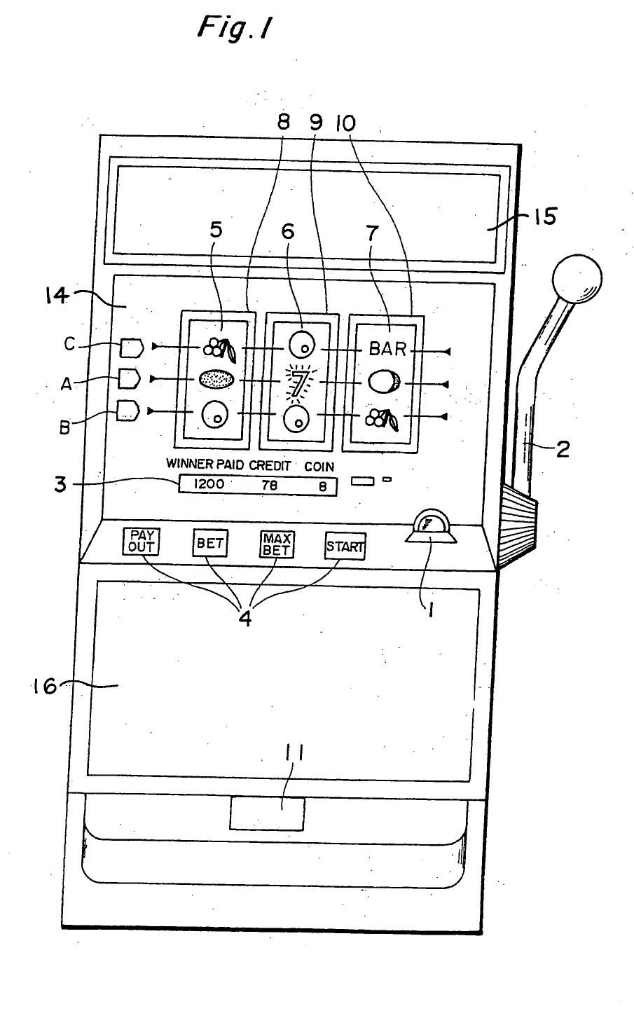

FIG. 1 is a front view of a gaming machine that incorporates the present invention.

Many other types of gaming machine designs may also be used with the inventions.

A player deposits a coin into coin slot 1 to obtain a playing credit. Other devices for generating playing credits include bill acceptors, ticket slots, card slots, and any other known device. A starting handle 2 may be pulled by the player to start the game.

Displays 3 display any useful information, such as the amount of the last win, the total credits, and the number of coins deposited.

Player control buttons 4 perform various functions such as pay out (coins), bet, max bet, and start (spin reels). Reel strips 5, 6, and 7 are revealed through transparent windows 8, 9, and 10, respectively.

A coin tray 11 receives coins paid out by the gaming machine.

Top display glass 14 surrounds the transparent windows 8, 9, and 10 and displays any information or design. Bottom display glass 16 typically displays the logo of the game.

By betting a sufficient number of credits, three pay lines A, B, and C may be activated, where designated symbol combinations across an activated pay line pay predetermined awards to the player. Conventional aspects of reel-type gaming machines are extremely well known and need not be described herein.

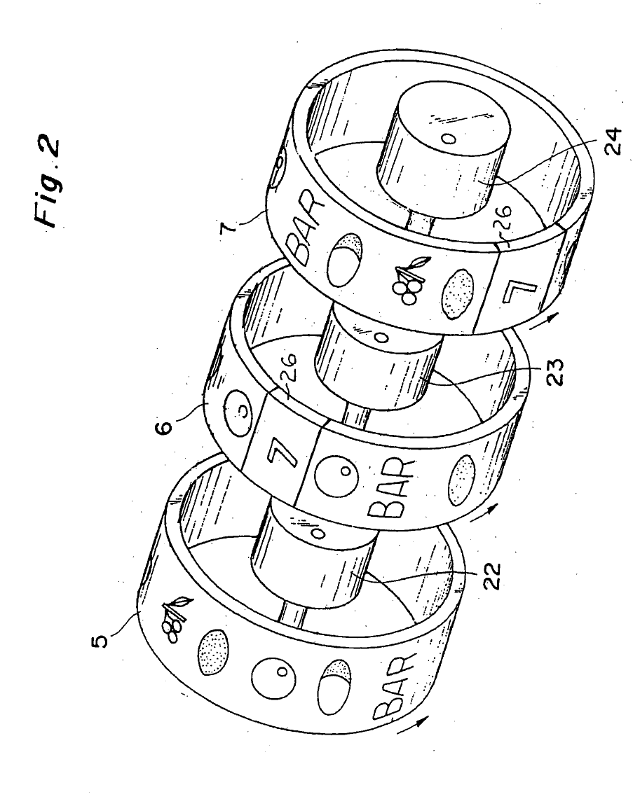

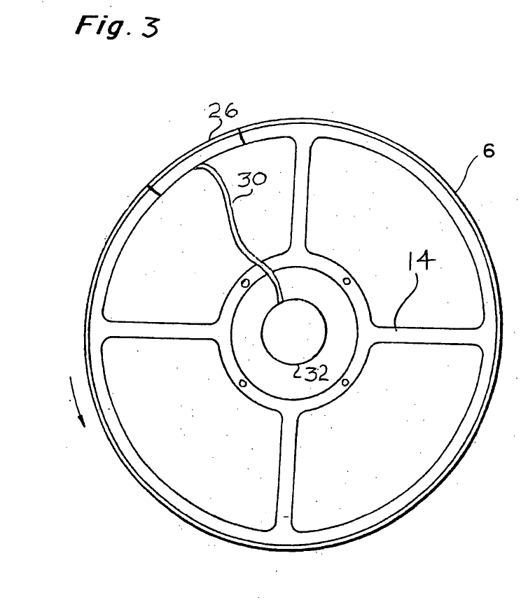

FIG. 2 is a perspective view of three reels with reel strips 5, 6, and 7 around the periphery of the reels. A reel is formed of a light plastic frame 14 (FIG. 3). Stepper motors 22, 23, and 24 rotate a predetermined amount with each pulse applied to the stepper motor. As in a typical gaming machine, the final positions of the three reels are predetermined by a random number generator within the gaming machine. The required number of pulses to rotate the reels to their predetermined positions is determined by a microprocessor, and the pulses are applied to each stepper motor. The final positions of each reel represent displayed symbols in windows 8, 9 and 10. The appropriate award for any winning symbol combination across a pay line is then paid to the player.

To add excitement to the game and to distinguish the gaming machine from other reel-type gaming machines, one or more of the symbols on the reel strip for one or more of the reels is a color organic light emitting diode (OLED) display 26. OLED displays are commercially available. An OLED display is a full-color flat-panel display with a level of brightness, wide viewing angle, and sharpness not possible with traditional flat-panel displays. OLEDs are self-luminous, in contrast to liquid crystal displays, and have a distinctly different look. The benefits of OLED displays over LCDs include an unlimited viewing angle, very high contrast, and much higher speed responses. They are extremely thin and lightweight, making them well suited for portable and flexible applications. Some of the many descriptions of OLED displays include U.S. Pat. Nos. 5,844,363; 5,952,789; 6,097,147; and 6,483,236; all incorporated herein by reference.

The particular symbol displayed by the OLED display 26 in FIG. 2 is the symbol 7. An OLED display controller selectively provides energization signals to X and Y coordinates in an LED array to create a bright image in any color. The control of an OLED display and the construction of a flexible OLED display necessary to form any symbol are well known in the field of OLED display technology.

In FIG. 3, the flexible OLED display 26 portion attached to the reel frame 14 is shown having an electrical cable 30 connected to a slip connector 32, which includes electrical contacts that rotate with the shaft of the stepper motor and stationary contacts that make electrical contact to corresponding rotating contacts to provide uninterrupted electrical contact as the reels are rotating. Such rotatable contacts are well known. Examples of such contacts include U.S. Pat. Nos. 6,331,117 and 4,583,798, incorporated herein by reference. Cable 30 includes power and signal wires. The resolution (LEDs per unit length) can be virtually any number, such as five per centimeter. Decoding circuitry may be fixed on the reel frame 14 so that serial or parallel encoded signals through cable 30 can be decoded by circuitry proximate to display 26 to energize any number of LEDs in display 26.

The control of display 26 is performed in software in conjunction with known display controller technology, which stores a pattern of bits in a memory corresponding to the image to be displayed. An energization scheme of display 26 may be a raster scan that selectively energizes the LEDs by row and column at a rapid rate.

As the reels are spinning, the player is attracted by the illuminated symbols on the OLED displays 26. When the reels stop spinning, the OLED displays 26 may change its presentation depending upon the outcome of the game, such as if the special symbols displayed by OLED displays 26 are involved in a winning combination. There may be one or more symbols displayed by an OLED display 26 on a reel strip. For example, all symbols on the reel strip may be displayed by an OLED array. Display types other than an OLED may also be used.

A reel-type gaming machine is described in U.S. Patent Application Publication U.S. 2003/0060269 A1, filed Sep. 27, 2001, incorporated herein by reference. That application describes a reel-type slot machine, where each reel strip is a flexible OLED display so that each of the symbols is represented by a pattern of energized LEDs on a reel strip. In that application the main purpose of using the OLED reel strip is for changing the symbols for different games with no physical changes to the machine. Once a game starts, the symbols are fixed in position on the rotating reels. The device disclosed in the Publication U.S. 2003/0060269 A1 would be difficult and expensive to implement due to the rotating large electronic display.

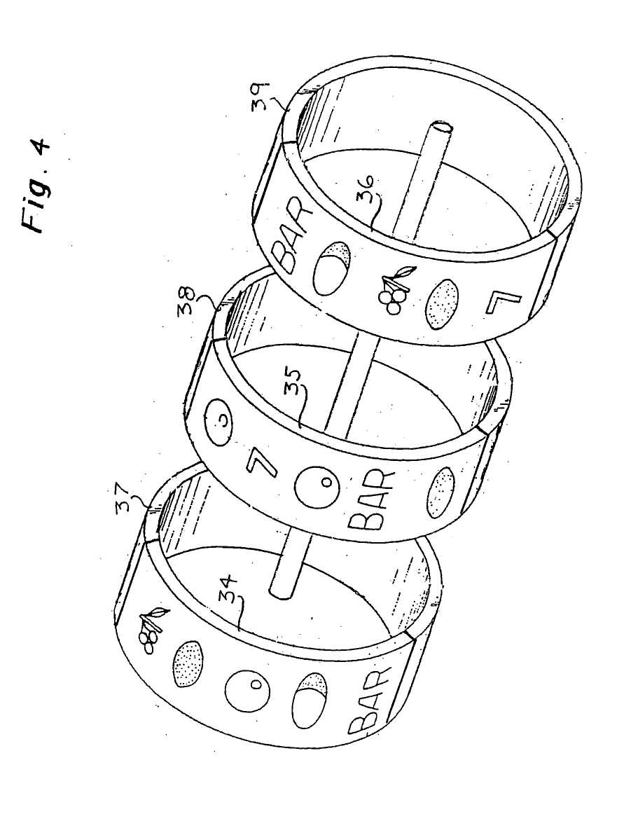

In one embodiment, shown in FIG. 4, a flexible OLED display 34, 35, 36 forms a visible portion of each stationary reel. The portions 37, 38, and 39 of the reels are not visible to the player and may even be deleted.

When a player presses the start button 4 or pulls lever 3, the symbols on the OLED displays 34, 35, and 36 scroll down (or up), giving the illusion to a player that reels are actually spinning. Scrolling of an LED display is well known and may involve simply shifting prestored symbol-forming bits in a video memory as is done in a video gaming machine.

Accordingly, the player is provided the excitement of a bright multi-colored display, and the gaming machine manufacturer can produce an inexpensive gaming machine without moving parts, such as stepper motors.

When the stationary reels appear to stop, the OLED symbols may change into any form to highlight a symbol, or to convey information, or to show a celebratory display, or to identify the winning symbol combination, etc. A displayed symbol can randomly turn into any other symbol, such as a wild card symbol with added functions. Virtually anything performed in conventional video-type gaming machines may be performed on the OLED displays 34, 35, and 36. In addition, any bonus game can be easily performed where the symbols on displays 34, 35, and 36 are changed for the bonus game as a result of a special outcome of the main game. Display types other than an OLED may also be used.

Referring back to FIG. 1, display windows 8, 9, and 10 may be a transparent display screen that can display any image in the foreground of the reel strips. The reel strips may be conventional, or may be any of the reel strips described with respect to FIGS. 2 and 4. A suitable display window may be a liquid crystal display, which can selectively produce clear pixels or colored pixels, where red, green, and blue components of a backlight are selectively blocked by the pixels in the liquid crystal display. The display need not be electronic but may use reflection to present an image in front of the reels.

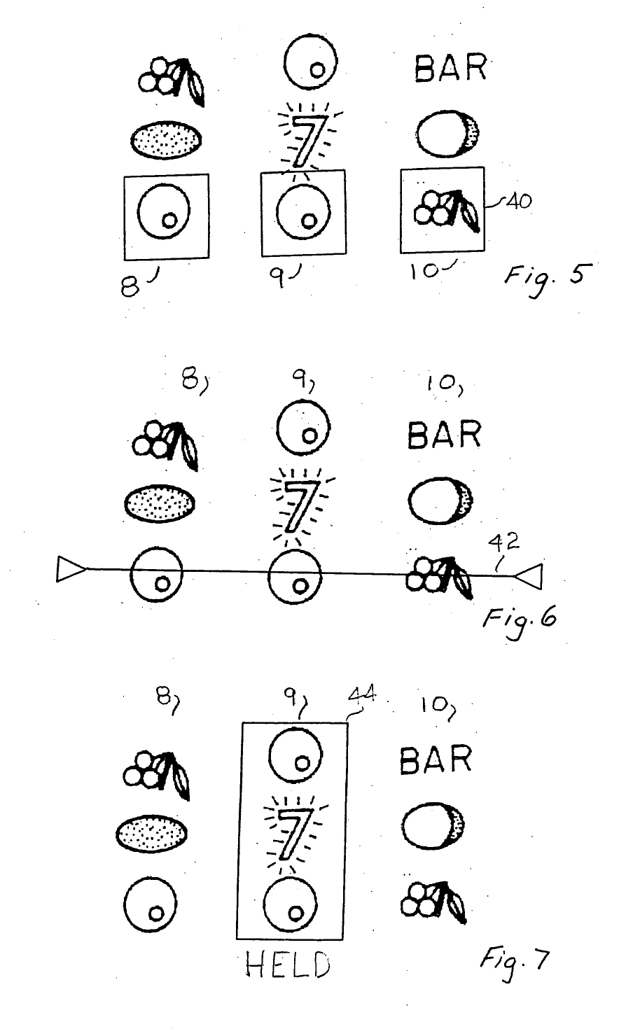

FIG. 5 illustrates how the LCD windows 8, 9, 10 can be controlled to form a frame 40 around each symbol in a winning combination to highlight the combination, assuming two oranges and a cherry result in an award to the player.

FIG. 6 illustrates how LCD windows 8, 9, and 10 can be controlled to highlight the pay line 42 that has a winning symbol combination across it.

The transparent display windows 8, 9, and 10 can additionally be a touch screen, where the X-Y position of a changed capacitance caused by a player's fingertip touching the screen is sensed. The X-Y position is cross-referenced with a function to be performed. The touch screen may be used to display information to the player or to designate a selection by the player. In FIG. 7, the gaming machine is the type that allows the player to hold a reel stationary for a next game if the player believes the displayed symbols are advantageous. A frame 44 (or other highlighting image) may appear around a reel or symbol that has been held by the player touching the screen in front of that reel. Any information or icons may be displayed by the windows 8, 9, and 10 in front of the reels. In another example, question marks may appear on windows 8, 9, and 10 asking the player to make a selection by touching one or more of the question marks to select a reel or symbol.

Control of an LCD display is well known and need not be described herein. The light that illuminates the reels may be the backlight for the LCD. Alternatively, additional backlighting sources may be optically coupled to the edges of the LCD display window. Such light sources may be red, green, and blue LEDs or a white light. Red, green, and blue pixels in the LCD display window are energized to display any symbol or any information on windows 8, 9, and 10. The windows 8, 9, and 10 can be a single display panel or separate display panels. Other transparent display windows may be used instead of an LCD.

In another embodiment, display windows 8, 9, and 10 are transparent touch screens that do not have the capability to display images. Such touch screens are well known and include capacitive, piezoelectric, and other types of touch screens. One type of capacitive touch screen is described in U.S. Pat. No. 5,579,036, incorporated herein by reference. A player may “touch” a reel or symbol to hold the reel or symbol, or to otherwise make a selection, by touching an area of the touch screen corresponding to the selection.

In another embodiment, any portion of the top display glass 14, 15 or the bottom display glass 16, or any combination of them, may be OLED displays that can be controlled to display any image. As such, the display glass does not need to be replaced if the machine is configured to play a different game. Control of OLEDs is well known. The image displayed can be static to display information for a particular game or may change depending on the status of the game being played. For example, the display glass may have an attract mode, a play mode, and a celebration mode for a player win. The display glass may also be a LCD or any other type of programmable display.

Recently, flat panel displays with pixels that hold their on or off states even after power has been removed have become commercially available. Therefore, the programmable display glass may be programmed to display anything without further processing by the gaming machine's microcomputer until it is time to change the display. Such a display is sometimes referred to as electronic paper. Reconfiguring the gaming machine for a new game would require a one time reprogramming of the display glass. This display glass in combination with the OLED reels and other inventions described herein enable a gaming machine owner to change the game played and the appearance of the gaming machine with only a software change for the displays and a game program change. This reconfiguration may be done remotely via a server or performed at the gaming machine.

In all embodiments of the OLED or LCD display glass 14-16 or display windows 8-10, a touch screen lamination may be employed that, when touched by the player or casino operator, performs a function related to the image displayed in the touched area. Such touch screen laminations and controllers are well known and need not be further described. For example, the active display glass may display various games that may be played, and the player touches the image that corresponds to the game to be played. The active display glass may also display a bonus game, and the player touches the display glass to make selections in the bonus game. The casino operator may use the touch screen over the display glass to configure the machine to, for example, play a certain game or have certain characteristics.

As an example of the use of the touch screen over the display glass 14-16 or display windows 8-10 for playing a bonus game, after a certain win by the player in the main game (either a video or reel game), the player may be given the choice to double the prize. The choice may be presented by one or more virtual buttons on the active display glass displaying a “double or nothing” icon or a quit icon. A risk ladder can be displayed on the display glass. The risk ladder may display the possible winnings by the player progressively winning the random double or nothing game up to a jackpot amount. The display glass may show the doubled prize actually won by the player on the risk ladder. For each win or upon another occurrence, the display glass may display animation to heighten the player's excitement.

The display glass or display windows may be backlit or lit from a side edge, if appropriate.

In another embodiment, the display presented by the display glass 14-16, the display windows 8-10, or the main video display (e.g., a CRT or LCD screen) within an opening in display glass 14 may be a 3-dimensional (3-D) display. A touch screen lamination covers the 3-D display, or the touch sensitive portion appears to coincide with the displayed image, so the player can make selections or control the game by touching a 3-D image. For example, the game displayed on the main video screen of the gaming machine may be a driving game where the driver must steer through a maze, and a steering wheel is perceived by the player as a 3-D wheel. The player may hold or touch a touch-sensitive device that corresponds with the apparent location of the 3-D image. By the player contacting the touch-sensitive device, the image on the screen may be changed or some other function is performed.

Typically, a 3-D image is presented to the player by presenting two offset images, a first image being viewed by the player's left eye and the other image being viewed by the player's right eye. Such techniques may use an array of narrow vertical lenses so the player's eyes, each having a different viewing angle, see two slightly different images by operation of the lenses, giving the impression of a 3-D image. Such 3-D imaging techniques are known. Manufacturers of 3-D display systems include Optical Products Development Corporation in Elmira New York. Optical Products manufactures an attention-getting 3-D display for slot machines that has no utility in controlling a game.

Another type of display that may be used for the display glass 14-16, the display windows 8-10, or on any other portion of the machine is a holographic type of display. Such a display would also have the touch screen lamination over the display so the player may touch a holographic image to control the game. Various holographic presentations suitable for use are described in U.S. Pat. No. 6,377,238, incorporated by reference. A hologram is a 3-D image created and produced by interference patterns on a surface. The hologram may be a reflection hologram or a transmission hologram. Creating holograms is well known. Holographic control buttons superimposed on a touch screen lamination gives the player the illusion of 3-D buttons, yet the control is solid state. The touch-sensitive holographic images are not limited to buttons. Such images may include bonus games, symbols, or any type of icon (e.g., a steering wheel).

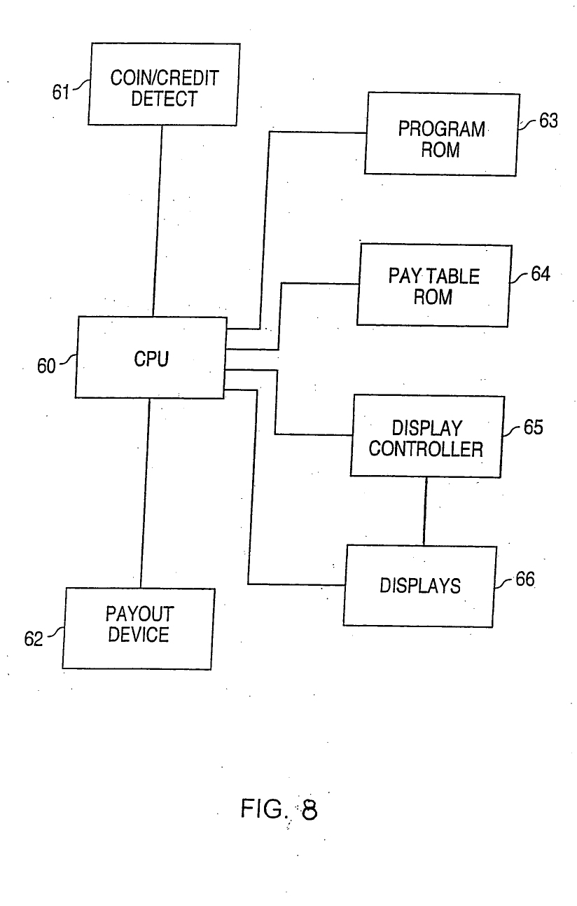

FIG. 8 illustrates basic circuit blocks in a suitable gaming device incorporating the present invention. A control unit (CPU 60) runs a gaming program stored in a program ROM 63. A coin/bill/credit detector 61 enables the CPU 60 to initiate a next game. A pay table ROM 64 detects the outcome of the game and identifies awards to be paid to the player. A payout device 62 pays out an award to the player in the form of coins upon termination of the game or upon the player cashing out. The payout device 62 may instead generate a payout in the form of a coded paper ticket, credits on a smart card or magnetic strip card, or in any other form. A display controller 65 receives commands from the CPU 60 and generates signals for the various displays 66, including the LCD and OLED displays. Player commands may be input through the buttons or touch screen into the CPU 60.

Each feature described herein can be used in a gaming machine by itself or in combination with the other features. Having described the invention in detail, those skilled in the art will appreciate that, given the present disclosure, modifications may be made to the invention without departing from the spirit of the inventive concepts described herein. Therefore, it is not intended that the scope of the invention be limited to the specific embodiments illustrated and described.

What is claimed is:

1. A gaming device comprising:
a main display for displaying a main game to a player, the main game granting awards to the player for certain random outcomes of the main game;
an electronic display other than the main display, the electronic display being an organic light emitting diode (OLED) display controlled to display images; and
a touch detection device over at least a portion of the OLED display for detecting a location touched by the player and carrying out a function corresponding to an image on the OLED display.

2. The device of claim 1 wherein the OLED display overlies a portion of an outer housing of the gaming device.

3. The device of claim 1 further comprising a controller to control the OLED display to display a bonus game, the bonus game being enabled upon one or more certain outcomes of the main game.

4. The device of claim 3 wherein the touch detection device allows the player to make selections for the bonus game.

5. The device of claim 1 wherein the main display is an electronic display device.

6. The device of claim 1 wherein the main display comprises a plurality of rotatable reels.

7. The device of claim 1 wherein the OLED display is below the main display.

8. The device of claim 1 wherein the OLED display is above the main display.

9. The device of claim 1 wherein the OLED display is along a side of the main display.

10. The device of claim 1 wherein the OLED display is controlled to display a bonus game to the player.

11. The device of claim 1 wherein the OLED display is controlled to display an identity of the main game to the player.

12. A method performed by a gaming device comprising:
conducting a main game on a main display;
controlling an organic light emitting diode (OLED) display to display images, the OLED display being located in areas other than in an area of the main display;
receiving touch signals from a touch sensitive device overlying at least a portion of the OLED display; and
performing a function pursuant to the touch signals.

13. The method of claim 12 wherein the OLED display is below the main display.

14. The method of claim 12 wherein the OLED display is above the main display.

15. The method of claim 12 wherein the OLED display is along a side of the main display.

16. The method of claim 12 wherein controlling the OLED display comprises controlling the OLED display to display a bonus game to the player, and wherein performing a function pursuant to the touch signals comprises performing a function in carrying out the bonus game.

17. The method of claim 12 wherein controlling the OLED display comprises controlling the OLED display to display an identity of the main game to a player.

18. A gaming device comprising:
a main display for displaying a main game to a player, the main game granting awards to the player for certain random outcomes of the main game;
a three-dimensional display other than the main display, the three-dimensional display presenting a three-dimensional image of a control device to the player; and
a touch detection device for detecting a touching by the player of the perceived three dimensional image and generating control signals for carrying out a function.

19. The device of claim 18 wherein the three-dimensional display is a holographic display to cause the player to perceive a three-dimensional image.

20. The device of claim 18 wherein the three-dimensional display comprises a display that presents offset images to a player to cause the player to perceive a three-dimensional image.

21. The device of claim 18 wherein the three-dimensional display displays a control device in a bonus game.
